(19) United States
(12) Patent Application Publication
(10) Pub. No.: US 2008/0015891 A1
(43) Pub. Date: Jan. 17, 2008

(54) Method and System to Assess an Acute and Chronic Disease Impact Index

(75) Inventor: Diane Lee, Orlando, FL (US)

Correspondence Address: AKERMAN SENTERFITT, P.O. BOX 3188, WEST PALM BEACH, FL, 33402-3188, US

(73) Assignee: MEDai, Inc., Orlando, FL (US)

(21) Appl. No.: 11/457,089

(22) Filed: Jul. 12, 2006

(51) Int. Cl. G06Q 10/00; G05B 13/02

(52) U.S. Cl. 705/2; 700/36

(57) ABSTRACT

A system (100) and method (300) is provided to assess an acute and chronic healthcare impact index of a patient. The impact index identifies patients having a highest potential impact for reducing program health-care costs. The method can include forecasting a health-care resource use of the patient, converting the health-care resource use to a monetary value, ranking the monetary value by an opportunity cost, and generating a score from the ranking. The score can identify patients having high health-care cost savings potential. The opportunity cost can be the projected cost of a health-care benefit, such as the cost of the emergency room visit or an in-patient length of stay.

### FIELD OF THE INVENTION

The embodiments of the invention herein relate to health management systems, and more particularly to use of health care resources.

### BACKGROUND

Medical outcomes represent the cumulative effect of one or more processes on a patient at a defined point in time. A process can be a health care plan, program, or service targeted to improve the health or overall quality of life of a patient, and can include but is not limited to medical and pharmaceutical aspects. The process can result in a continuous quality improvement when a patient's progress can be monitored or measured in view of the process. This can include tracking events over time and identifying patterns of variation with reference to a standard means of measurement. A continuous quality improvement process provides a structure for understanding outcomes and resolving patient care process issues associated with the health care plan.

Outcome measurement and assessment help health care providers understand and identify processes or health care behaviors that lead to an overall improvement in applied health care. For example, comparative outcome measurements such as infection rates, cost, and mortality, are of considerable importance to front-line providers of patient care, to payers, and to patients themselves. The analysis of these clinical and resource outcomes can help providers understand individual elements of care processes that can be improved upon. The analysis can allow for focused attention on key elements and identify strategies for process improvement. Accordingly, a process can be changed to redirect focus where the analysis reveals areas for improvement. Once a process has been changed, re-measurement of the outcome in the changed process enables providers to evaluate the effect and impact of the changes.

Outcome measurements can be risk adjusted; that is, outcomes can be adjusted based on a level of severity. Severity adjustment attempts to account for socioeconomic and biologic differences among patients. Without adjusting for patient severity, the comparison and interpretation of outcomes may have limited interpretation. For example, an older patient may respond differently to a same treatment plan applied to a younger patient. One can expect different outcome values for a 78 year old female with co-morbid conditions such as osteoarthritis and diabetes undergoing a hip replacement compared to the same procedure in an otherwise healthy 32 year old male athlete. In another aspect, severity adjustment provides a standardization across health care practices. For example, in the profiling a provider's performance, one may ask whether Physician A has a higher rate of poor outcomes than Physician B. This may be determined by considering whether Physician A cares for more severely ill patients than Physician B (and normalizing their patients for comparison purposes), or is Physician A's poor performance related to some other cause such as treatment pattern or pharmacy choices. Artificial intelligence can be applied to providing answers to these questions by attempting to mimic the cognitive and symbolic skills of humans. Systems applying principles of artificial intelligence are capable of making inferences based on an available set of knowledge.

Artificial intelligence is generally defined as a class of computer science concerned with the automation of intelligent behavior. It encompasses a variety of computer technologies such as rule-based expert systems, genetic algorithms, neural networks, fuzzy logic and robotics. AI systems incorporate multiple technologies and processes to provide highly accurate forecasting and data profiling for severity indexing. Al systems employ statistical models by which output from predictive models can be converted into a severity classification scale. The scale can be reflective of the degree of illness of individual patients. In one implementation, an AI system can employ multivariate regression techniques to model outcomes for severity adjustment based on a set of dependent variables.

Severity indexing methodologies can generally use one of two approaches: a “normative” approach or an “empirical” approach. A normative design can be used when a group of medical experts map out decision paths or rules stating the conditions that comprise each severity level. The experts can derive decision trees, validated with statistical tests, that represent how well the severity index predicts patient outcomes. In contrast, “empirical” design can utilize historical data and statistical tools such as regression analysis to develop a model that optimally predicts patient outcome. However, these approaches do not address uses of resources associated with predicted health care outcomes. A need therefore exists for identifying health care resource use for improving upon current implementations of health care service and delivery plans.

### SUMMARY

Embodiments of the invention concern a computer implemented method to assess an acute healthcare impact index of a patient. The acute healthcare impact index identifies patients having a highest potential impact for reducing program health-care costs. The method can include forecasting a health-care resource use of the patient, converting the health-care resource use to a monetary value, ranking the monetary value by an opportunity cost, and generating a score from the ranking. The score can identify patients having high health-care cost savings potential. For example, the health-care resource use can be an emergency room visit or an in-patient length of stay. The opportunity cost can be the projected cost of a health-care benefit, such as the cost of the emergency room visit, incurred by the patient.

The acute healthcare impact index can be evaluated to determine if a health-care action plan is needed. The action plan can be provided to patients having a score greater than a pre-determined threshold which can reduce the cost of the forecasted resource. For example, the action plan provides patients with a forecasted number of acute care stays for lowering health-care consumption costs based on the assessed acute healthcare impact index. In one arrangement, the score can be presented in an interactive web-based interface which includes the forecasted resource use, monetary value, ranking, opportunity cost, and patient name or information.

In one aspect, the acute healthcare impact index can be an outcome measurement for a disease such as Diabetes, COPD, Asthma, Congestive Heart Failure, Coronary Artery Disease, Depression, Hyperlipidemia, or CVA/TIA. In another aspect, a forecasted acute care cost for a population of patients can be created for identifying groups of patients having high cost savings potential. In one arrangement, the forecasting can include collecting the patient's health-care data for providing a statistical review, performing a data integrity scrubbing of health care data to facilitate the statistical review, and submitting the scrubbed data after the statistical review to an artificial intelligence program to generate a forecast use of the health-care resource. The artificial intelligence program can employ abductive and inductive reasoning, neural networks, nearest neighbor pairing or other techniques for generating the forecast.

Embodiments of the invention also concern a method for assessing a chronic healthcare impact index of a patient. The chronic healthcare impact index reveals the degree to which a patient adheres to provided health-care guidelines for managing their disease. The chronic healthcare impact index provides a ranking that identifies a patient's compliance for maximizing a level of future cost savings potential. Cost savings can be maximized when patients adhere to health-care guidelines for managing their disease. The method can include identifying a disease of the patient, identifying a level of compliance of the patient for monitoring the disease, determining a severity score of the patient in view of the disease, and assigning a compliance score to the patient based on the level of compliance and the severity score. The step of determining a severity score can include predicting a severity of illness from a set of independent variables. The method can further include determining chronic health-care costs associated with the patient's disease, and assessing a cost savings potential based on the compliance score in view of the chronic cost. A patient can be expected to monitor their disease by following provided guidelines to comply with a treatment plan for the disease. A patient that effectively monitors their disease can be expected to have lower cost savings potential. A patient that does not effectively monitor their disease can be expected to have higher cost savings potential.

The method can further include ranking a cost savings potential for each patient within a group of patients, and presenting the ranking through a web-interface for identifying patients following a treatment plan guideline. Cost saving potential can be converted to monetary terms by evaluating a cost difference between a first year and a second year for patients that followed guidelines and for patients that did not follow the guidelines. In one arrangement, a prediction engine can be employed to evaluate the cost savings potential. The method can further include accounting for catastrophic co-morbidities and outlier-costs within said prediction that limit cost savings potential.

Embodiments of the invention also concern a software system for identifying patients with high health-care cost savings potential. The system can include a data collection unit for collecting a patient's health-care data, a scrubber unit for performing a data integrity scrubbing, a prediction engine for ranking cost saving potential of resources forecast to be used by the patient, and a graphical user interface for presenting a score of the ranking. The score identifies patients having high health-care cost saving potential. The prediction engine can process scrubbed health-care data for a statistical review, generate a forecast of a health-care resource used by the patient, convert the health-care resource use to a monetary value, and rank the monetary value by an opportunity cost.

In one aspect, the prediction engine can assesses a chronic healthcare impact index of said patient by identifying a disease of the patient, identifying a level of compliance of the patient for monitoring the disease, determining a severity score of the patient in view of the disease, assigning a compliance score to the patient based on the level of compliance and the severity score, determining a chronic health-care cost associated with the patient's disease, and assessing a cost savings potential based on the compliance score in view of the chronic cost.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 presents a system for identifying health-care cost savings in accordance with an embodiment of the inventive arrangements;

FIG. 2 presents a method of predicting a severity of illness in accordance with an embodiment of the inventive arrangements;

FIG. 3 presents a method for assessing an acute healthcare impact index in accordance with an embodiment of the inventive arrangements;

FIG. 4 presents a method for forecasting a health care resource in accordance with an embodiment of the inventive arrangements; and

FIG. 5 presents a method for assessing a chronic healthcare impact index using a disease-specific model in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “program” as used herein, is defined as a system of services, opportunities, or projects, generally designed to meet a social need.

Embodiments of the invention concern a computer implemented method for providing health care cost savings. The method can include forecasting a health-care resource use of a patient, converting the health-care resource use to a monetary value, ranking the monetary value by an opportunity cost, and generating a score from the ranking. The score can identify patients having high health-care cost saving potential. The method can be implemented in a system or tool to provide a unique opportunity for managed care organizations and disease management companies to produce cost savings for their customers. The system and method can provide case managers and other personnel the tools they need to mine data for the patients that will provide the greatest opportunity for cost savings and high cost care avoidance.

Notably, outcome measurements can reveal which programs or processes provide improvement or continued benefit. This can include the allocation of health care resources. Accordingly, embodiments of the invention concern a method of assessing an acute and chronic healthcare impact index using a disease-specific model for identifying cost savings potentials or resources utilized for health care services and delivery.

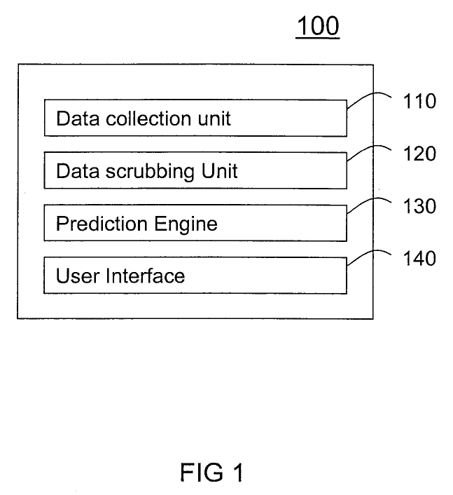

### FIG. 1

Referring to FIG. 1, a system is shown for identifying health-care cost savings for a patient. The system can determine an acute healthcare impact index and a chronic healthcare impact index for a patient for realizing cost savings potential. The system 100 can predict the value of a dependent variable, such as length of stay, death, or expense charges, from a set of independent variables which are often clinical and demographic factors. The predicted outcomes can be used to project a use of resource, and accordingly a cost of use associated with using such resources. The system 100 can include a data collection unit 110, a data scrubbing unit 120, a prediction engine 130, and a user interface 140. The data collection unit 110 can collect a patient's health-care data for providing a statistical review. The scrubber unit 120 can perform a data integrity scrubbing. The prediction engine 130 can process the scrubbed data for statistical review, generate a forecast of a health-care resource use by a patient, convert the health-care resource use to a monetary value, and rank the monetary value by an opportunity cost. The user interface 140 can present a score from the ranking, in which the score identifies patients having high health-care cost saving potential. The data collection unit 110, the scrubber unit 120, and the prediction engine 130 can each be accessed and configured through the user interface 140. The user interface 140 can be a windows based application running on a computer, a server, or a communications device. The user interface 140 can provide program functionality to open data files, save data into files, process data, display data, and allow a user to change, enter, or delete data. The system 100 can be deployed on a computer, a network, over an internet, a health care system, or the like.

The prediction engine 130 can determine a chronic healthcare impact index of a patient by identifying a disease of the patient, identifying a level of compliance of the patient for monitoring the disease, determining a severity score of the patient in view of the disease, assigning a compliance score to the patient based on the level and the severity score, determining a chronic health-care cost associated with the patient's disease, and assessing a cost savings potential based on the compliance score in view of the chronic cost. The prediction engine can provide an overall disease-specific severity score, a benchmark value for at least one measure within a disease category, and a severity-adjusted expected value for each measure. In one arrangement, the prediction engine applies a weighted average for each measure to establish the severity-adjusted expected value.

Notably, the system 100 identifies a patient's state of health prior to forecasting the resources expected to be used by that patient. The scores and values provide an overall assessment for a patient's health with regard to a disease of record with the patient. The software system 100 identifies patients having high potential cost savings based on the severity of their illness and their current medical condition. High costs are generally attributed in part due to poorly managed allocation of resources for treating a patient when the use of resources is unknown. Understandably, the system 100 forecasts a patient's use of resources in order to predict a patient's future or projected use of those resources. Accordingly, a health administrator or health care provider may negotiate a more favorable rate when the use of resources is known in advance.

The severity score can describe the severity of illness for a patient having a particular disease. The benchmark value can describe an average value associated with a general population of patients having the same disease. The benchmark value can include statistical bounds wherein a patient can be considered to fall within a certain severity category with regard to the disease population sample. The severity-adjusted expected value can be the severity score weighted by a set of influential independent severity variables. The set of influential independent severity variables can be most influential in assigning patients to a severity category or score. Influential variables such as those describing age, body systems affected, or co-morbid diagnoses provide significant weight in assigning the severity score.

Understandably, a disease can be characterized by a certain set of measures describing observable or testable conditions related to the disease. For example, a disease may be characterized as affecting or targeting a certain organ or bodily system, for which the organ or bodily system can be tested or measured for showing signs of the disease. Health indicator variables herein termed independent variables can express conditions related to the disease. These variables can be used as measures to monitor the effectiveness of a treatment plan for managing the disease. For example, the data collection unit 110 can collect patient data including health indicator variables, medical history, and specific patient information. The data collection unit 110 can save patient health-care data in a database making it available to internal or external health-management systems. The health-care data can include measures which can be independent variables or dependent variables. The data collection unit 110 can make the data available to a user of the system 100 through a user interface 140. For example, the user interface 140 can be a web-based interface or it can be a computer software application.

The user interface 140 can allow a user to update, edit, delete, modify, or store patient data. For example, the software system 100 can be accessed during the course of a patient's treatment plan, wherein health indicator variables are updated in accordance with the patients health. The system 100 can store a history of the variables which allows for statistical analysis on the data. The system 100 includes a data scrubber 120 which allows a user to validate the integrity of the health care data for a particular patient or for a population of patients. In general, the data scrubber 120 allows a user to partition data, check for completeness, accuracy, and appropriateness across both clinical and financial levels. For example, an incorrect entry of a resource use can be detected and updated using the data scrubber 120.

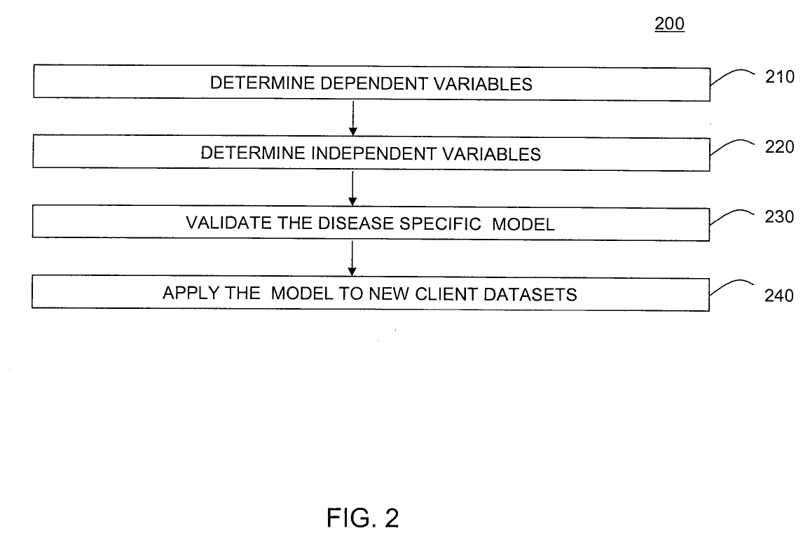

### FIG. 2

Referring to FIG. 2, a method of predicting a severity of illness using an AI system is shown. The method can include identifying dependent variables 210, identifying independent variables 220, validating a disease-specific model 230, and applying the model to a client data set 240. Understandably, the method steps 210-240 provide an overall disease-specific Severity Score, a Benchmark Value for each measure within a disease and a Severity-Adjusted Expected Value for each measure. Validation of the disease-specific model can include conducting clinical QA of the results. The severity score can be a rating of 1, 2, 3, 4 or 5, which describes the level of severity, with 5 being the most severe.

The first step in predicting a severity of illness includes determining the dependent variables 210. The dependent variable consists of resource and quality outcomes that are evaluated by the disease-specific model in order to determine which independent severity variables have the most influence on good or poor outcomes. For example, the outcome variables (i.e. composite dependent variable) for one particular disease condition can be one or more of the following: Length of Stay, Brain Death, Cardiac Arrest, Mortality, Acute Renal Failure, Hospice/Homecare/SNF Discharge, Respiratory Failure, Sepsis, or Additional Disease Specific (i.e., Maternal and Baby Death). The outcome variables are not limited to these and other outcome variables associated with other diseases or illnesses are herein contemplated. Independent variables can be entered into the disease-specific model to determine a change in the outcome variables. For example, an independent variable such as age may produce a different outcome for a certain disease. The dependent variables and associated outcome can be determined by the independent variables.

At step 220, a list of independent severity variables can be determined. The list of independent severity variables can be fed into the disease-specific model. In one particular example, the disease-specific model can be a Neural Network, though embodiments of the invention are not limited to these. For example, the independent severity variables can consist of admission diagnoses, chronic co-morbidities, and demographic information but are not herein limited to these. Specifically not included in the independent variable set are any variables that include resource consumption measures, inpatient procedures, surgical procedures, discharge status, or complications. Notably, the independent variables are used to determine a change in the dependent variables which describe the outcome. Therefore, the dependent variables describing the outcome are not used themselves to predict changes in outcome.

As one example, a sample set of independent severity variables for the disease Myocardial Infarction with PTCA can include: MI Location Acuity (subendocardial /LAD), MI Risk, Body Systems Affected, Complete Atrioventricular Block, Female Gender, Diabetic Condition, COPD, Fluid & Electrolyte Disorder, Hypertensive Disorder, Other Acute/Subacute Forms of Ischemic Heart Disease, History of Previous CABG, Cholesterol/Lipoid Disorder, Chronic Renal Failure, Patient Age on Admission, Anemias, Atherosclerosis, Admit Category Acuity: NB-EL-UIR-ER, Drug Dependency Disorder, Emphysema, Smoker, and Obesity.

The severity variables can be analyzed by the disease-specific model to study the relationships between the severity variables and the outcome variable. The disease-specific model (e.g. neural network) can use known values for the outcome variable to create a pattern, or a mathematical equation, that leads from the severity variables to the determination of the outcome variable. The disease-specific model produces a final set of independent severity variables that have the most influence in the determining the composite outcome. Certain independent severity variables may be more influential than others. In practice, the most influential independent severity variables (i.e., age, body systems, and various co-morbid diagnoses) can be used as final determinate of whether a patient receives a Severity level of 1,2,3,4 or 5.

At step 230, the disease-specific model can be validated. The mathematical equation inherent in the weights of the trained disease-specific model can then be applied to a similar set of severity variables to predict the composite outcome in an out-of-sample dataset. That is, an untested data set is tested with the disease-specific model to determine a performance level. The outcome variables that are predicted in the out-of-sample set are then compared to the actual outcome variable for each patient. The statistical correlation achieved between the predicted and actual values can be reported using an R² statistic. This value represents the out-of-sample statistical validation of the model developed.

The disease-specific model can employ one of abductive and inductive reasoning, neural networks, and nearest neighbor pairing. Outcomes of the disease-specific model can be validated by a clinical committee that reviews the variables as displayed across severity levels. The clinical staff can sign off or attest that the variable rates across severities correlate with the medical conditions expected for each specific disease.

At step 240, the disease-specific model can be applied to a new client dataset. In practice, the severity variables for an actual sample of patients are fed into the disease-specific model to determine a predicted outcome. This predicted value can be converted to a predicted severity score between 1 and 5 using percentiles to distribute the patients across the categories. A benchmark table can be created that displays an average value for each measure in that disease and at each of the five severity levels. In one arrangement, a weighted average for each measure can be used to establish the Severity-Adjusted Expected Value. Understandably, patients who have a predicted outcome variable that scores better than the actual composite-outcome variable can be placed in a target column of the Benchmark Table. The target column indicates that a particular group had better actual results than were predicted based on their severity variables. The target group can represent a best-of-practice and can serve as a measure to benchmark outcomes.

Notably, the disease-specific model is based on statistical prediction, it uses patient characteristics such as diagnoses and chronic disease present at admission, creates one score for severity of illness incorporating death, it is driven by quality outcomes plus resources to determine admission diagnostic characteristics that define severity, and it includes at least 40 disease categories based on ICD-9 groupings that are relevant to clinical analysis.

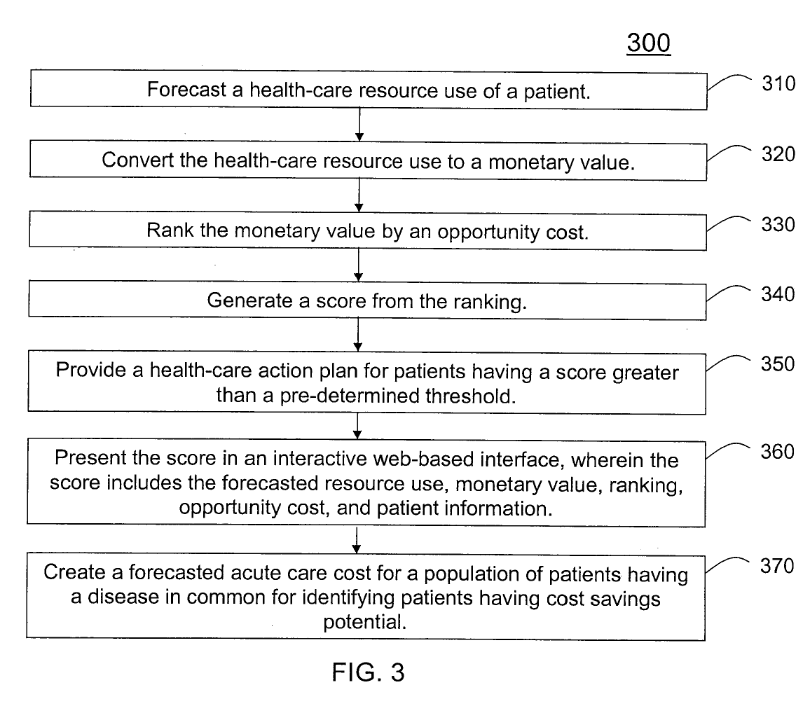

### FIG. 3

Referring to FIG. 3, a method to assess an acute healthcare impact index of a patient is shown. The acute healthcare impact index identifies patients having a highest potential impact for reducing program health-care costs. When describing the method 300, reference will be made to using the system 100 for performing certain method steps, although it must be noted that the method 300 can be practiced with any other suitable system or device. Moreover, the steps of the method 300 are not limited to the particular order in which they are presented in FIG. 3. The inventive method can also have a greater number of steps or a fewer number of steps than those shown in FIG. 3. The Acute healthcare impact Index was created in order to provide customers with a ranking of individuals that could provide savings by avoiding high cost care. In general, high acute care usage indicates members with uncontrolled diseases. That is, patients having uncontrolled or chronic diseases generally incur a high allocation and use of resources than patients capable of better managing or handling their health-care treatment plan.

At step 310, a health-care resource use of a patient can be forecast. A health-care resource can be an emergency room visit or a hospital stay. Understandably, a patient of record may have a medical history concerning an acute illness or a chronic illness. A chronic illness which is generally long term can require more use of resources than an acute illness which is generally short term and may not require a committed and recurring use of resources. A hospital, a health care administrator, a management team, or a group can keep a record of patients. The records can include files describing a patient's health, prior medical history, illnesses, prior hospital visits and the like. The file can also include independent variables related to the patient's health and which are not related to resource use. The variables can consist of admission diagnoses, chronic co-morbidities, and demographic information but are not herein limited to these. Specifically not included in the independent variable set are any variables that include resource consumption measures such as inpatient procedures, surgical procedures, discharge status, or complications. The independent variables can be submitted to a prediction engine that can forecast a use of resources in view of the patients record or file. In particular, the prediction engine processes the independent variables and produces a forecasted estimate of resource use based on the severity of illness of a patient.

For example, a patient can exhibit a number of health conditions which can be ranked by level. The health conditions and associated levels are entered into the disease-specific model as independent variables which results in the prediction of a severity level. For example, a patient having a myocardial infarction may have independent variables that describe the number of organs affected, the risk of heart attack, the location of pain, or symptom types and severity. A doctor or nurse can assess the patient's condition and assign values to the independent variables. The model can collectively analyze the severity of the independent variables and output a severity score for each dependent outcome (e.g. measure) of the disease. Notably, the disease-specific model can also estimate a forecast of resources utilized in view of the conditions and based on previous diagnoses and patient records. Understandably, the disease-specific model can have been previously trained on data having already associated resource use with severity levels or health conditions. Accordingly, the disease-specific model has learned associations with certain health conditions, severity levels, outcomes, and resource uses from previous records or data.

At step 320, a health-care resource can be converted to a monetary value. For example, the predicted number of in-patient hospital stays or emergency room visits associated with a severity level can be assigned a monetary value. Understandably, the use of resources has a financial cost that can be determined from current charges or costs. Use of the resource is generally paid out by a payer such as an insurance provider, a health-care provider, a hospital, or a patient. For example, the disease-specific model can forecast a predicted number of in-patient hospital stays or number of ambulance uses. The patient's particular health condition or disease treatment may follow a general trend of resource use that can be observed or predicted by the disease-specific model. The number of hospital stays or the number of resource uses can be converted to a monetary value.

At step 330 the monetary value can be ranked by an opportunity cost. The opportunity cost can be the cost of resources foregone or sacrificed when selecting one health service or care product over another. Namely, the opportunity cost is the savings cost associated with projecting the forecast resource use to an incurred expense. That is, the opportunity cost describes the cost of savings if the estimate is correctly predicted. For example, the disease-specific model may predict that a patient will visit an emergency room 20 times over the course of a year. The payers of the service may elect to negotiate arrangements with the providers to lower the cost of the emergency room visits given the projected number of visits. The payers may forward negotiate an expense based on the number of visits. If the patient visits the emergency room less than the predicted number of visits, the opportunity cost can be the difference between the cost savings had the payer not entered into the agreement and the forward negotiated fee. The opportunity cost can also be considered the cost of a health-care benefit incurred by the patient.

At step 340, a score can be generated from the ranking, wherein the score identifies patients having high health-care cost saving potential. The disease-specific model projects severity levels and resource uses in view of provided health condition indicators. Notably, the number of resources used by patients can be ranked to determine which patients are predicted to require the highest use of resources. Understandably, the score describes which patients have the highest potential for cost savings. In one aspect, patients that are more particular and willing to manage their health care plan might not provide as significant cost savings as a patient that poorly manages their health care plan. Understandably, a patient that follows a prescribed treatment plan may incur less unexpected expenses than a patient that does not follow a prescribed treatment plan. The score can identify those patients that may not be following their plan, or that may need a change of plan if they are following the treatment plan.

Accordingly, at step 350, a health-care action plan can be provided for patients having a score greater than a pre-determined threshold for reducing a forecasted cost of the health-care resource use. As one example, the action plan can provide patients with a forecasted number of acute care stays for lowering health-care consumption costs based on an acute healthcare impact index.

At step 360, to assist payers and providers, outcome measures, severity scores, projected resource uses, monetary values, costs, expenses, and scores can all be provided through an interactive web-based interface. The web-based interface can be a internet technology platform wherein the payers and providers can receive outcome measures on-line. In another aspect, the method of assessing an acute healthcare impact index can include creating a forecasted acute care cost for a population of patients having a common disease for identifying patients having cost savings potential, as seen in step 370.

For example, forecasted Emergency Room Visits and Inpatient Length of Stay (LOS) can be predicted for each patient and then converted to dollars. The forecasted dollars are then converted to a percentile ranking for the entire database which can be forecast to acute care costs. The projected costs can be ranked in ascending order and represented as a percentage. Notably, the acute healthcare impact index assignment ranks individuals by opportunity to avoid high cost acute care.

At step 370, by providing a score for every patient in the database, a ranking of individuals has been provided that can provide significant savings by avoiding high cost care. Understandably, scores vary across patients, though those with scores in the range 97-100 range (as described below) may provide the greatest potential for controlling cost. The acute healthcare impact index can be represented as a percentile score wherein a score of 0 indicates patients with less then 0.5 predicted inpatient days divided by ER visits, and a score between 70-100 indicates patients with greater than or equal to 0.5 predicted inpatient days divided by ER visits. In practice, focusing on the higher end of the range, for example 97-100, may provide the patients with the highest predicted acute care stays that will provide the greatest potential for controlling cost

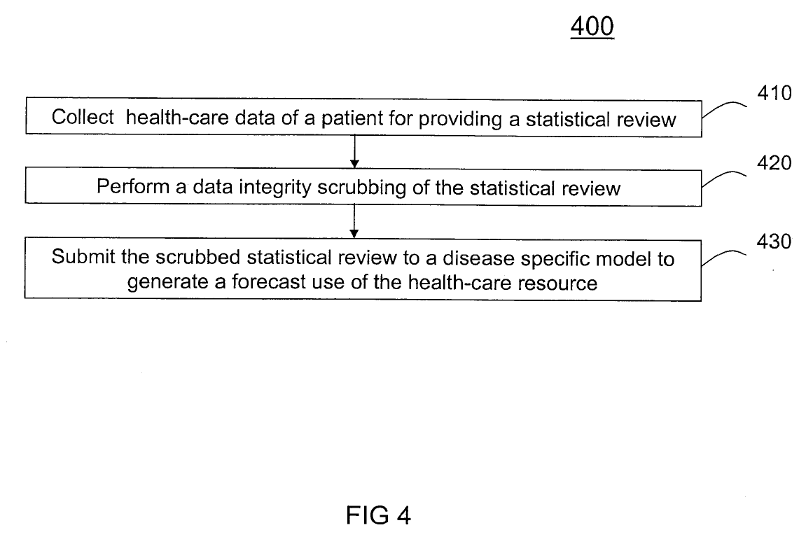

### FIG. 4

Referring to FIG. 4, a method for further forecasting a health care resource use of a patient is shown. At step 410, health-care data of the patient can be collected for providing a statistical review of the patient medical history and resource use. The disease-specific model requires sufficient data to generate informative decisions. In the case where the disease-specific model is a neural network, the neural network needs a significant amount of training data to make generalizations with regard to assessing severity of illness. The neural network can include a variety of connectionist algorithms (back propagation, general regression networks, probabilistic networks, abduction/induction networks) to produce models which predict severity. Three different AI processes—abductive/induction, neural networks, and nearest neighbor pairing—can be employed to determine the most influential clinical variables to use as outcome variables in the severity adjustment process. Understandably, the input and output variables change with each disease population and a better fit of variables makes for a better fit of the final solution. In one arrangement, the Al generated rules associated with the neural network can be simple, declarative sentences pointing out the relationships between the data and the outcome solutions, i.e., when ABC drug is given under XYZ circumstance, patients have superior outcomes.

At step 420 a data integrity check can be performed by scrubbing the data prior to a statistical review. Performance of a neural net architecture can degrade if the data within the sample is noisy, inaccurate, or insufficient. Data used for training the neural network can be checked for completeness, validity, and accuracy, as well as appropriateness across both financial and clinical levels. The financial aspects involve the use and allocation of resources associated with a patient's record or treatment plan. Training the neural net involves constant adjustment of the weights so that the outcomes generated by the neural network match the true outcomes as closely as possible. Training methods are generally based on heuristic (problem-solving strategy) tactics which make incremental improvements that require numerous iterations during optimization of the weights. In one arrangement, a training of the disease-specific model includes computing a first R² value of a dependent variable value in a test data set and a second R² value predicted by said trained model. The first R² value can be compared to the second R² value. A training of the disease-specific model can be stopped if the first R² value exceeds a pre-determined difference from the second R² value to limit overtraining.

At step 430, the scrubbed data can be submitted to a disease specific model to generate a forecast use of a health-care resource. Candidate dependent variables, or the variables to be predicted, are identified and each can be modeled using one or more of the aforementioned modeling algorithms. Candidate dependent variables can be broadly characterized as either being “quality outcome oriented,” such as brain death and cardiac arrest, or “resource oriented,” as in length of stay and profit. Quality oriented dependent variables are derived from measurements of adverse medical outcomes while resource dependent variables are usually based on length of stay (LOS). Frequently, the final dependent variable evolves as a hybrid of the two approaches. Severity levels can be evaluated against important outcome variables (LOS, complications, mortality, charge, etc.) to determine if the higher severity levels generate the expected higher (more severe) levels of the outcome variables.

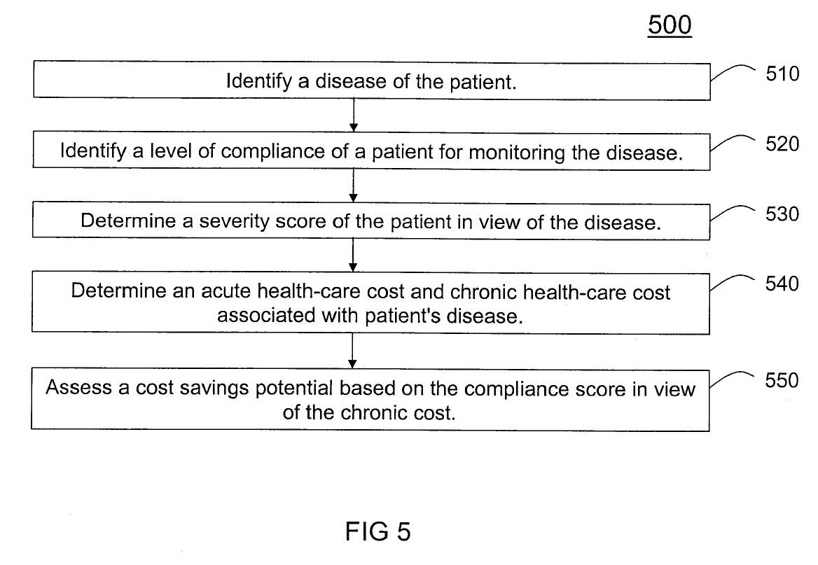

### FIG. 5

Referring to FIG. 5, a method 500 for assessing a chronic healthcare impact index of a patient is shown. The chronic healthcare impact index reveals the degree to which a patient adheres to provided health-care guidelines for managing their disease. The chronic healthcare impact index provides a ranking that identifies a patient's compliance for maximizing a level of future cost savings potential. Cost savings can be maximized when patients adhere to health-care guidelines for managing their disease. The method 500 is not limited to the order in which the steps are listed in the method 500. In addition, the method 500 can contain a greater or a fewer number of steps than those shown in FIG. 5.

The Chronic healthcare impact Index identifies patients that can produce the highest level of future savings potential, when the patients adhere to basic care guidelines. Notably, the chronic healthcare impact index identifies patients that may need changes to their current health care treatment program or whose treatment program is inadequate for the severity of their condition. The Chronic healthcare impact Index can assess cost saving projections for the various diseases and illnesses. The chronic healthcare impact index can rank individuals on future savings potential, apply weights to gaps and gap diseases in order to forecast savings opportunity, and generate a score that identifies patients that can produce the highest level of future savings potential. The method to assess a chronic healthcare impact index applies to such diseases having established treatment plans or health care guidelines for managing the disease, such as Diabetes, COPD, Asthma, Congestive Heart Failure, Coronary Artery Disease, Depression, Hyperlipidemia, and CVA/TIA, but is not herein limited to these.

At step 510, a disease of the patient can be identified. For example, patients with chronic diseases for which health care guidelines are provided or available are identified. Understandably, the method monitors patient's adherence to a set of guidelines associated with treatment for the disease and which is presented to the patient for managing the disease. For example, a dialysis patient may have treatment plan guidelines which describe diet or exercise programs for the patient. The first step in assessing the chronic healthcare impact index is identifying those patients who are currently enrolled under a treatment or guideline program. Accordingly, a score will determine how well the patient is adhering to the guidelines and whether cost-savings are available given knowledge of the patient's adherence to the plan. Patients having diseases not associated with a treatment plan or guideline can be issued a zero chronic healthcare impact score indicating a NA (not available) status. Understandably, cost savings improvements are primarily targeted to patients not complying with treatment plan guidelines. Patients that do have one of the aforementioned diseases having an associated treatment plan, but have been compliant with all their disease guidelines will generally not have future dollar savings potential. These members will appear with a chronic healthcare impact score of 10 to identify patients who are compliant with their guidelines.

At step, 520, a patient level of compliance can be identified for monitoring the disease. Notably, the level of compliance reveals how committed the patient is to following the guidelines, and accordingly what resources may be predicted for future use in view of the compliance. Patients who have one of the aforementioned diseases and are noncompliant are assigned a cost savings in dollars. In practice, a difference in annual costs can be predicted for those members who followed guidelines vs. those who did not to determine potential cost savings. For example, a first difference in cost from a first year to a second year can be evaluated for patients that followed guidelines, and a second difference in cost from a first year to a second year can be evaluated for patients that did not follow the guidelines. The disease-specific model can include a prediction engine that estimates the cost saving potential based on the disease and level of patient compliance in view of the cost differences.

At step 530, a severity score of the patient in view of the disease can be determined. For example, health condition measures can be entered into a disease-specific model. The disease-specific model can determine a severity score based on the health condition measures. Determining a severity score can also include predicting a severity of illness from a set of independent variables. The predicting can account for catastrophic co-morbidities and outlier-costs that limit cost savings potential.

At step 540, a chronic health-care cost associated with patient's disease can be determined. For example, the disease-specific model can predict a resource use and convert the resource use to a chronic health-care cost. At step 540, a cost savings potential can be assessed based on the compliance score and the chronic cost. The cost savings potential may be maximal for patients not following the guidelines, and the cost savings potential may be minimal for patients following said guidelines. In one aspect, the cost savings potential can be ranked for each patient within a group of patients. The score, ranking, and associated outcomes can be presented through a web-interface for identifying patients following a treatment plan guideline. This can help payers and providers monitor patients complying with a treatment plan or guideline for their disease.

The cost savings for non-compliant patients who have one of the aforementioned diseases can be converted to a Chronic Healthcare Impact Index using a percentile ranking. The ranking identifies patients having a highest potential for cost savings. A generally acceptable range for the ranking is between 70-100, though more specific ranges such as 86-100 or 93-100 may be used depending on the number of noncompliant patients. Potential costs savings can be intentionally biased downwards for non-compliant patients with catastrophic diseases or outlier-costs due to catastrophic treatment issues. The chronic disease index impact score for these patients tend to be at the lower end of the 70-100 range. In practice, focusing on the higher end of the range, for example 97-100 may provide the greatest opportunity for controlling cost and future cost savings.

Where applicable, the present embodiments can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A computer implemented method to assess an acute healthcare impact index of a patient comprising:
forecasting a health-care resource use of a patient;
converting said health-care resource use to a monetary value;
ranking said monetary value by an opportunity cost; and
generating a score from said ranking, wherein said score identifies patients having high health-care cost saving potential.

2. The method of claim 1, wherein said forecasting further includes
collecting health-care data of said patient for providing a statistical review;
performing a data integrity scrubbing of health care data to facilitate said statistical review; and
submitting said scrubbed data after said statistical review to a disease-specific model to generate a forecast use of said health-care resource,
wherein said disease-specific model employs a blend of linear and non-linear statistical predictive modeling technologies.

3. The method of claim 1, wherein a health-care resource use is one of an emergency room visit or an in-patient length of stay.

4. The method of claim 1, wherein said opportunity cost is the cost of a health-care benefit incurred by said patient.

5. The method of claim 1, further comprising converting emergency room (ER) and in-patient Length of Stay (LOS) measures to a monetary value.

6. The method of claim 1, further comprising presenting said score in an interactive web-based interface, wherein said score includes one of said forecasted resource use, said monetary value, said ranking, said opportunity cost, and said patient.

7. A computer implemented method to assess a chronic healthcare impact index of a patient comprising:
identifying a disease of the patient;
identifying a level of compliance of said patient for treating said disease;
determining a severity score of said patient in view of said disease; and
assigning a compliance score to said patient based on said level and said severity score.

8. The method of claim 7, wherein said forecasting further includes
collecting health-care data of said patient for providing a statistical review;
performing a data integrity scrubbing of health care data to facilitate said statistical review; and
submitting said scrubbed data after said statistical review to a disease-specific model to generate a forecast use of said health-care resource,
wherein said disease-specific model employs a blend of linear and non-linear statistical predictive modeling technologies.

9. The method of claim 7, wherein said determining a severity score includes predicting a severity of illness that incorporates primarily diagnostic and demographic independent variables and a cost-related dependent variable.

10. The method of claim 7, further comprising
determining a chronic health-care cost associated with patient's said disease; and
assessing a cost savings potential based on said compliance score in view of said chronic cost.

11. The method of claim 7, wherein said monitoring includes following provided guidelines to comply with a treatment plan for said disease.

12. The method of claim 10, wherein said cost savings potential is maximal for patients not following said guidelines, and said cost savings potential is minimal for patients following said guidelines.

13. The method of claim 12, further comprising creating a model that assigns a cost savings potential in monetary terms by
evaluating a first difference in cost from a first year to a second year for patients that followed guidelines; and
evaluating a second difference in cost from a first year to a second year for patients that did not follow said guidelines; and
during these evaluations incorporating the patient's disease, severity of illness, and guideline compliance.

14. A computer implemented method for:
ranking a cost savings potential for each patient within a group of patients; and
presenting said ranking through a web-interface for identifying patients that have the greatest potential for saving chronic healthcare costs.

15. A software system for identifying patients for health-care cost savings comprising:
a data collection unit for collecting a patient's health-care data for providing a statistical review;
a scrubber unit for performing a data integrity scrubbing of said data prior to a statistical review;
a prediction engine for
processing said scrubbed data,
generating a forecast of a health-care resource used by said patient,
converting said health-care resource use to a monetary value,
ranking said monetary value by an opportunity cost, and
a user interface for presenting a score from said ranking, wherein said score identifies patients having high health-care cost saving potential.

16. The software system of claim 15, wherein said prediction engine assesses a chronic impact index of said patient by:
identifying a disease of the patient;
identifying a level of compliance of said patient for monitoring and treating said disease;
determining a severity score of said patient in view of said disease;
assigning a compliance score to said patient based on said level and said severity score;
determining a chronic health-care cost associated with patient's said disease; and
assessing a cost savings potential based on said compliance score in view of said chronic cost.

17. The software system of claim 15, wherein said prediction engine provides an overall disease-specific severity score, a benchmark value for at least one measure within a disease category, and a severity-adjusted expected value for each said measure.

18. The software system of claim 15, wherein said prediction engine applies a weighted average for each said measure to establish said severity-adjusted expected value.

19. A computer implemented method to assess a severity of illness comprising:
identifying one or more dependent variables;
identifying one or more independent variables;
creating a disease-specific model from said dependent and independent variables;
validating said disease-specific model; and
applying the disease-specific model to client datasets.
